(19) United States
(12) Patent Application Publication
(10) Pub. No.: US 2009/0070177 A1
(43) Pub. Date: Mar. 12, 2009

(54) System and Method for Optimally Allocating Overlapping Inventory

(76) Inventors: Deepak Agarwal, San Jose, CA (US); Kishore Papineni, Carmel, NY (US); John Anthony Tomlin, Sunnyvale, CA (US); Madhu Vudali, Santa Clara, CA (US)

Correspondence Address: STATTLER - SUH PC, 60 SOUTH MARKET STREET, SUITE 480, SAN JOSE, CA, 95113, US

(21) Appl. No.: 11/852,898

(22) Filed: Sep. 10, 2007

(51) Int. Cl. G06Q 10/00

(52) U.S. Cl. 705/8

(57) ABSTRACT

The present invention introduces methods for allocating: overlapping inventory. In the system of the present invention overlapping inventory problems are reformulated as a network transport problem. Specifically, different inventory types are represented as inventory network nodes. Similarly, corresponding inventory requests are also represented as request network nodes. The different inventory network nodes corresponding to inventory that can satisfy inventory requests are coupled to the request network nodes associated with those inventory requests. A source node is then coupled to the inventory network nodes and a destination node is coupled to the request network nodes. A flow limit of the available inventory is assigned to the connections between the source node and the inventory network nodes. Finally, inventory requests that must be satisfied are represented as flow minimums between the request network nodes and the destination network node. The transport network problem is then solved to solve the corresponding overlapping inventory allocation problem.

### FIELD OF THE INVENTION

The present invention relates to the field of inventory allocation. In particular the present invention discloses techniques for analyzing and solving overlapping inventory allocation problems.

### BACKGROUND OF THE INVENTION

The global Internet has become a mass media on par with radio and television. And just like radio and television content, the content on the Internet is largely supported by advertising dollars. The main advertising supported portion of the Internet is the “World Wide Web” that displays HyperText Mark-Up Language (HTML) documents distributed using the HyperText Transport Protocol (HTTP).

Two of the most common types of advertisements on the World Wide Web portion of the Internet are banner advertisements and text link advertisements. Banner advertisements are generally images or animations that are displayed within an Internet web page. Text link advertisements are generally short segments of text that are linked to the advertiser's web site via a hyperlink.

To maximize the impact of internet advertising (and maximize the advertising fees that may be charged), internet advertising services need to display advertisements that are most likely to capture the interest of the web viewer. An interested web viewer will read the advertisement and may click on the advertisement to visit a web site associated with the advertisement.

To select the best advertisement for a particular web viewer, an advertising service should use whatever information is known about the web viewer. However, the amount of information known about the web viewer will vary heavily depending on the circumstances. For example, some web viewers may have registered with the web site and provided information about themselves while other web viewers may not have registered. Some registered web users may have completely filled out their registration forms whereas other registered web viewers may have only provided the minimal amount of information to complete the registration. Thus, the quality of the various different advertising opportunities will vary.

Since the quality of the advertising opportunities will vary, the advertising system should be careful to use the advertising opportunities in the most efficient manner possible. For example, an advertising opportunity for an anonymous web viewer is not as valuable as an advertising opportunity for a web viewer who has registered and provided detailed demographic information. Thus, it would be desirable to be able to optimally allocate the various different advertising opportunities to different advertisers and advertising campaigns.

### SUMMARY OF THE INVENTION

The present invention introduces methods for allocating overlapping inventory. In the system of the present invention overlapping inventory problems are reformulated as a network transport problem. Specifically, different inventory types are represented as inventory network nodes. Similarly, corresponding inventory requests are also represented as request network nodes. The different inventory network nodes corresponding to inventory that can satisfy inventory requests are coupled to the request network nodes associated with those inventory requests. A source node is then coupled to the inventory network nodes and a destination node is coupled to the request network nodes. A flow limit of the available inventory is assigned to the connections between the source node and the inventory network nodes. Finally, inventory requests that must be satisfied are represented as flow minimums between the request network nodes and the destination network node. The transport network problem is then solved to solve the corresponding overlapping inventory allocation problem.

Other objects, features, and advantages of present invention will be apparent from the accompanying drawings and from the following detailed description.

### BRIEF DESCRIPTION OF THE DRAWINGS

The objects, features, and advantages of the present invention will be apparent to one skilled in the art, in view of the following detailed description in which:

FIG. 1 illustrates a conceptual diagram of a user at a personal computer system accessing a web site server on the Internet that is supported by an advertising service.

FIG. 2 illustrates a Venn diagram containing various overlapping sets of advertising opportunities.

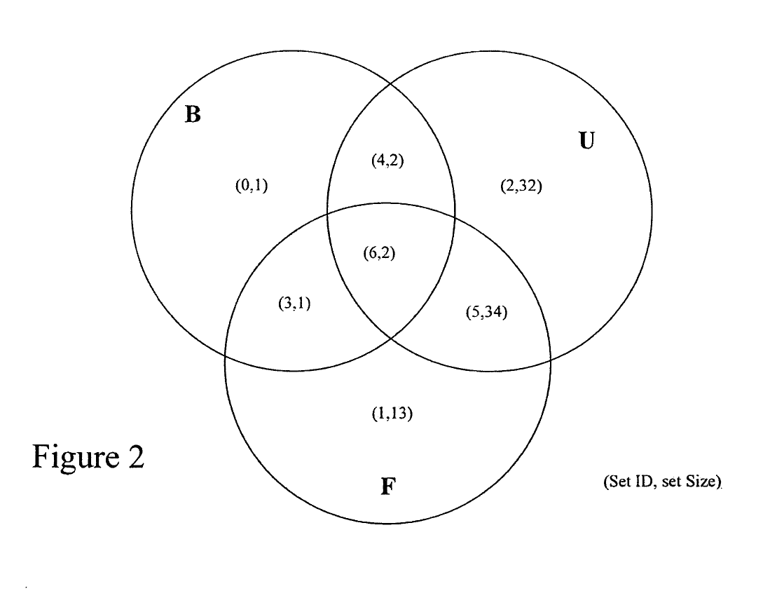

FIG. 3A illustrates a set of advertising opportunity nodes and a set of advertising request nodes.

FIG. 3B illustrates the set of advertising opportunity and advertising request nodes of FIG. 3A wherein the allowed paths for fulfilling an advertising request for node 0 are depicted.

FIG. 3C illustrates the set of advertising opportunity and advertising request nodes of FIG. 3B wherein all of the allowed paths for fulfilling an advertising request are depicted.

FIG. 3D illustrates the set of advertising opportunity and advertising request nodes of FIG. 3C wherein a source node has been added.

FIG. 3E illustrates the set of advertising opportunity and advertising request nodes of FIG. 3E wherein a destination node has been added creating a full network formulation of the overlapping inventory problem of FIG. 2.

FIG. 4 illustrates a network graph formulation of the objective function in equation (3) with the overlapping inventory data of FIG. 2.

FIG. 5 illustrates a network graph formulation of the objective function in equation (5) with the overlapping inventory data of FIG. 2.

### DETAILED DESCRIPTION

Methods for optimally allocating overlapping inventory are disclosed. In the following description, for purposes of explanation, specific nomenclature is set forth to provide a thorough understanding of the present invention. However, it will be apparent to one skilled in the art that these specific details are not required in order to practice the present invention. Furthermore, although the present invention is mainly described with reference to allocating different advertising opportunities the World Wide Web, the same techniques can easily be applied to other types of overlapping inventory allocation problems.

### Advertising Support for Commercial World Wide Web Sites

The World Wide Web portion of the global Internet has become a mass media that largely operates with commercial web sites that are supported by advertising. Specifically, web site publishers provide interesting content that attracts web site viewers and the web site publishers intersperse paid advertisements into the web pages. The fees from the advertisers compensate the web site publisher for the web site hosting and the costs of creating the interesting content that attracts the web viewers. Some internet web site advertisements are ‘banner advertisements’ consisting of an advertiser-supplied graphical image or animation. Other internet web site advertisements merely consist of simple short strings of text and hyperlinks.

### Internet Advertising Example

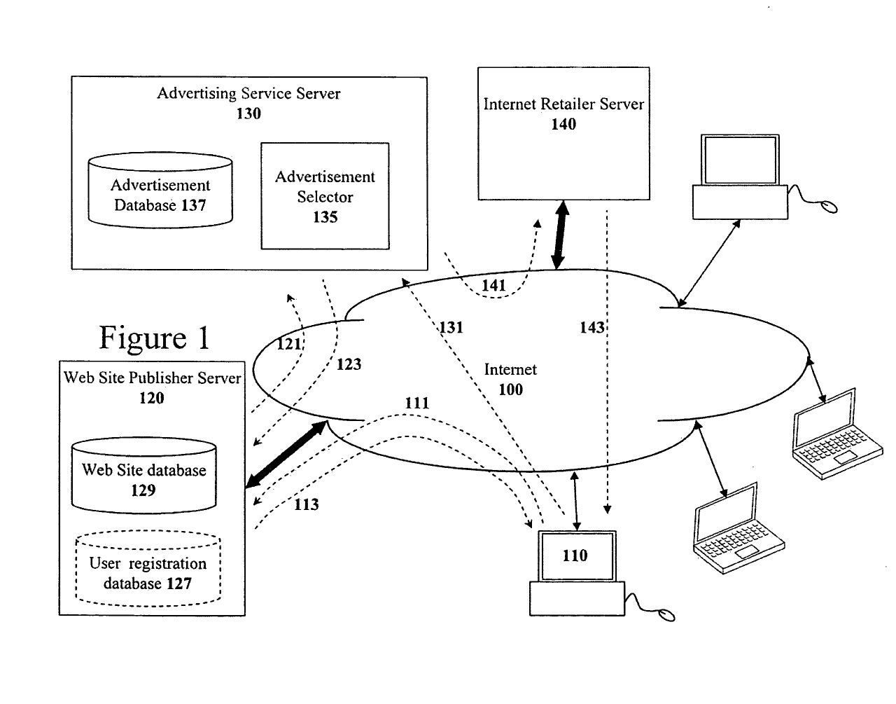

The advertisements within an advertisement-supported web site are often provided to a commercial web site publisher by an internet advertising service. FIG. 1 illustrates conceptual diagram of how an internet advertising service and a web site publisher operate.

Referring to FIG. 1, an internet based retailer server 140 that sells products to Internet users may wish to seek additional customers. Thus, that Internet based retailer may sign up with an internet advertisement service 130 in order to promote the web site of the internet based retailer. The internet advertisement service 130 will handle the display of internet advertisements by attempting to place the advertisements within web sites that have web viewers who may be interested in the products sold by the internet based retailer.

The web site served by Web site publisher server 120 may contain web pages viewed by web viewers interested in the internet retailer's services. Thus, when an internet user at personal computer 110 requests a web page published by web site publisher server 120 (along request communication 111) web site publisher server 120 may subsequently request an advertisement from internet advertisement server 130 (along request 121) and receive an advertisement for the internet retailer (along response 123). The web site publisher server 120 will then deliver the requested web page along with the selected advertisement along response 113 such that the user at personal computer 110 is exposed to an internet advertisement that advertises the offerings of the internet retailer server 140.

If the internet user at personal computer 110 is sufficiently interested in what is presented within the advertisement, the internet user may click on the advertisement such that the user will be re-directed to the internet retailer server 140. The user will be re-directed to the internet retailer server 140 through an advertising service server 130 that will record the user's selection of the advertisement in order to bill the advertiser for the selection of the advertisement. Once the user has been re-directed to the internet retailer server 140, the user at personal computer 110 may purchase goods or services directly from the internet retailer server 140.

### Targeted Internet Advertising

Web site publisher server 120 may have a user registration database 127 wherein web site publisher server 120 stores information about users who have registered with the web site in order to obtain premium content. When a registered web viewer visits web site publisher server 120, then web site publisher server 120 may provide some demographic information about that registered user to advertising service server 130 along advertisement request 121. An advertisement selector 135 at advertising service server 130 may user that demographic information about the web viewer: in order to select an advertisement specifically tailored for the demographic group of that web viewer.

Furthermore, web site publisher server 120 may provide the IP address from the web viewer's personal computer 110. In some cases, advertisement selector 135 may use an IP-address-to-geographic-location look-up table to: determine a general geographic location of web viewer's personal computer 110. Thus, advertisement selector 135 may use that general geographic location when considering what advertisement to select for display to that web viewer.

Over time, advertising server 130 can statistically determine what proportion of advertising opportunities will have detailed demographic information, what proportion of advertising opportunities will be from a certain geographic locations and other useful advertising forecast information. That advertising forecast information can be used to optimize the usage of the advertising opportunities. Note that the various classes of users may overlap. For example, a user may be from the USA, a registered user, both, or neither. A registered or non-registered user from the USA can be used for an advertisement to be displayed to Americans. This overlapping inventory can pose a difficult allocation problem.

### The Overlapping Advertising Inventory Problem

FIG. 1 illustrates a Venn diagram of one possible forecast for advertising opportunities (also known as advertising inventory). Each different advertising inventory set is labeled with two numbers in parenthesis “(#,#)” wherein the first number indicates a set identifier and the second number indicates a number of impressions (in millions) projected to be available in the time period.

In the diagram of FIG. 1 the advertising opportunities have been divided into three groups: advertising opportunities that may be Behaviorally-Targeted (labeled ‘B’ in the diagram), advertising opportunities for Females (labeled ‘F’ in the diagram), and advertising opportunities for web viewers located in the USA (labeled ‘U’ in the diagram). The intersections of the fields represent advertising opportunities that satisfy more than one condition. For example, set 4 (labeled “(4,2)” on the diagram) represents advertising opportunities for people in the USA (set ‘U’) that may be behaviorally targeted (set ‘B’).

The sets of available advertising inventory are used to satisfy requests for advertising inventory that have various requirements. The sets may be labeled as sets Sₖ={f₁^{k}, . . . , f_{M}^{k}} where fᵢ^{k} is set to one if the set or subset k matches field i, and zero otherwise. The sets illustrated in FIG. 1 are:

TABLE 1
B, F, U

S₀ = {1, 0, 0} B
S₁ = {0, 1, 0} F
S₂ = {0, 0, 1} U
S₃ = {1, 1, 0} BF
S₄ = {1, 0, 1} BU
S₅ = {0, 1, 1} FU
S₆ = {1, 1, 1} BFU

Referring to FIG. 1, the second number in each parenthesis pair is the available inventory in millions for a specific set, excluding proper subsets. Thus, although there is total of 70 million impressions in the U pool (2), the number shown is 32 because it excludes the inventory in the proper subsets BU, FU and BFU. Similarly, the inventory of set FU is 36 million but shown as 34 million by the pair (5,34) since it excludes the 2 million units in proper subset BFU.

If not disjoint, the subsets of a set Sₖ may be obtained by putting in 1's where the set has 0's. A set Sⱼ is subset of Sₖ if fᵢ^{j} is 1 for all i where fᵢ^{k} is 1. Thus, e.g. S₆⊂S₀, . . . , S₅, S₃⊂S₁ and S₀⊂S₃, S₄, S₆.

The various subsets of FIG. 1 define pools of targeted advertising inventory. Advertising inventory from a pool may only be assigned to an advertising opportunity request for a profile if that pool belongs to a subset (inclusive) of the requested pool. Thus, to satisfy a particular advertising inventory request, the advertising inventory must exactly match the request profile or be a proper subset of the request profile. For example, an advertising request for an ‘F’ advertising opportunity may be satisfied from set 1 (‘F’), set 3 (‘BF’), set 5 (‘FU’), or set 6 (‘BFU’).

The following list of elements can be used to fully define the overlapping inventory optimization problem:

Indices

j, k=1, . . . ,R The indices of the relevant sets

Data

R The number of relevant sets to the requests

rₖ (Aggregate) requested volume for profile k

dₖ Size of the inventory pool k

Sₖ={fᵢ^{k}, . . . ,f_{M}^{k}} Set of characteristics of pool k

Vₖ Expected future value of inventory in pool k

Variables

Xⱼₖ Volume of pool j inventory assigned to request(s) for inventory type k

yⱼ Unused inventory in pool j

Constraints

Pool Sizes (Supply)

$${\sum }_{k \vert {S}_{j} ⊆ {S}_{k}} {x}_{jk} + {y}_{j} = {d}_{j} ∀ j \qquad ( 1 )$$

Satisfying Inventory Requests (Demands)

$${\sum }_{j \vert {S}_{j} ⊆ {S}_{k}} {x}_{jk} \geq {r}_{k} ∀ k \qquad ( 2 )$$

The objective function to optimize is somewhat arbitrary, since we have no real demand forecast, but it has the general form:

First Objective Function

$$Maximize {\sum }_{k} {V}_{k} {y}_{k} \qquad ( 3 )$$

Since more information available for targeting an advertisement will generally yield better results, one may assume that the advertising opportunities with more targeting information are more valuable. Once example of weights following this assumption would be to set the value of pools 0, 1 and 2 to a value of 1; set the value of pools 3, 4 and 5 to a value of 2; and set the value of pool 6 to a value of 3. This objective function will ensure that allocations for inventory requests will maximize the value of the remaining inventory.

An alternative objective might be to satisfy a set of requests and provide the maximum the amount of a certain type inventory. To accomplish this goal, a new variable is introduced, one of the constraint equations is changed, and the objective function is changed. Suppose that the goal is to satisfy the requests and provide the maximum amount of the available quantity of set Sᵢ. Then we modify the i^{-th} constraint of inequality (2) to be:

Modified Constraint

$${\sum }_{j \vert {S}_{j} ⊆ {S}_{i}} {x}_{ji} - z \geq {r}_{i} \qquad ( 4 )$$

leaving the other constraint inequalities the same for k≠i. The second objective function is then:

Second Objective Function

Maximize z. (5)

To fully explain the problem to be solved several examples are hereby provided. These examples will draw from the advertising inventory data illustrated in FIG. 1. Furthermore, all the examples, will assume that the following inventory requests (in millions) must be satisfied:

USA=30

Female AND USA=20

Female=15

BAND USA=1

### EXAMPLE 1

In the first example, the goal is to allocate advertising opportunities win a manner that maximizes the first objective function while satisfying the above requests.

After solving the problem in the optimal way, the results are:

Pool 2 supplies 30 to request for USA.

Pool 5 supplies 20, to request for Female AND USA.

Pool 1 supplies 13 to request for Female.

Pool 3 supplies 1 to request for Female.

Pool 5 supplies 1 to request for Female.

Pool 3 supplies 1 to request for B AND USA.

which leaves an unused inventory with optimal value of:

Pool 0 has unused inventory of 1.

Pool 2 has unused inventory of 2.

Pool 4 has unused inventory of 1.

Pool 5 has unused inventory of 13.

Pool 6 has unused inventory of 2.

### EXAMPLE 2

In a second example, the goal is to satisfy the requests and provide the maximum available USA inventory. Solving the second objective function with linear programming returns the value 18 USA opportunities. If this additional inventory is booked, the allocation would then be:

Pool 2 supplies 32 to request for USA

Pool 4 supplies 1 to request for USA

Pool 5 supplies 15 to request for USA

Pool 5 supplies 18 to request for Female AND USA

Pool 6 supplies 2 to request for Female AND USA

Pool 1 supplies 13 to request for Female

Pool 3 supplies 1 to request for Female

Pool 5 supplies 1 to request for Female

Pool 4 supplies 1 to request for B AND USA

which leaves the unused inventory:

Pool 0 has unused inventory of 1.

### EXAMPLE 3

In a third example, the goal is to satisfy the above requests and provide the maximum available Female inventory. Solving the second objective function with linear programming returns the value 15 Female advertising opportunities. The new allocation would be:

Pool 2 supplies 30 to request for USA.

Pool 5 supplies 20 to request for Female AND USA.

Pool 1 supplies 13 to request for Female.

Pool 3 supplies 1 to request for Female.

Pool 5 supplies 14 to request for Female.

Pool 6 supplies 2 to request for Female.

Pool 4 supplies 1 to request for B AND USA.

which leaves the following unused inventory:

Pool 0 has unused inventory 1

Pool 2 has unused inventory 2

Pool 4 has unused inventory 1

### EXAMPLE 4

In a fourth and final example, the goal is to satisfy the above requests and provide the maximum available inventory for Female AND USA. Solving the second objective function with linear programming returns the value 15 Female AND USA advertising opportunities. T he new allocation would be:

Pool 2 supplies 30 to request for USA.

Pool 5 supplies 33 to request for Female AND USA.

Pool 6 supplies 2 to request for Female AND USA.

Pool 1 supplies 13 to request for Female.

Pool 3 supplies 1 to request for Female.

Pool 5 supplies 1 to request for Female.

Pool 4 supplies 1 to request for B AND USA.

which leaves the unused inventory:

Pool 0 has unused inventory 1.

Pool 2 has unused inventory 2.

Pool 4 has unused inventory 1.

Both the first objective function and the second objective function can be analyzed with linear programming techniques in order to obtain the desired optimum allocation. However, such linear programming techniques are cumbersome and non trivial.

### Network Formulation of Allocation Problem

Inspection of the linear programming constraint equations (1) and (2) reveals that the variable xⱼₖ appears exactly once in each set of constraints. Furthermore, variable xⱼₖ has a un it (‘1”) coefficient. Variable xⱼₖ designates the volume of pool j inventory assigned to a request for inventory type k. This is similar to a transportation network wherein items from a source/pool node move to a destination/request node. After careful evaluation, it was indeed discovered that overlapping allocation problems can indeed be formulated as network transport problems when the correct network is created.

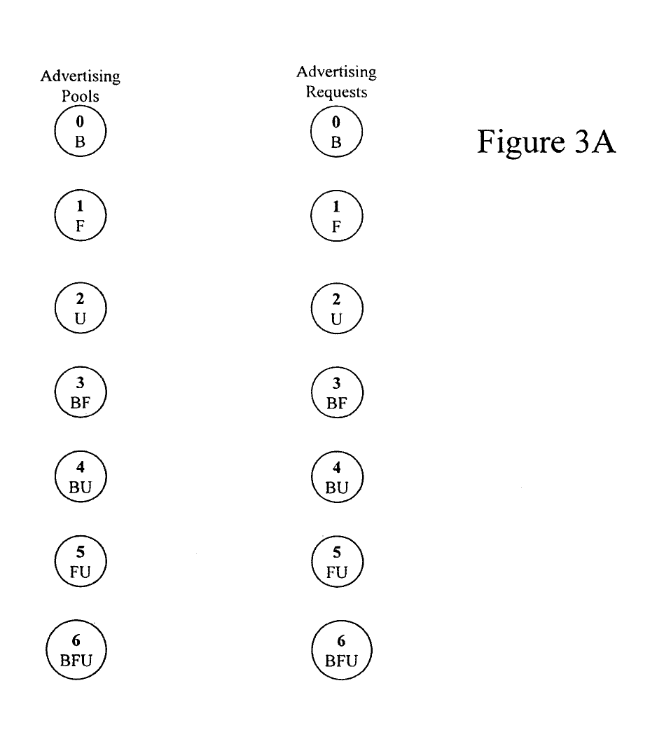

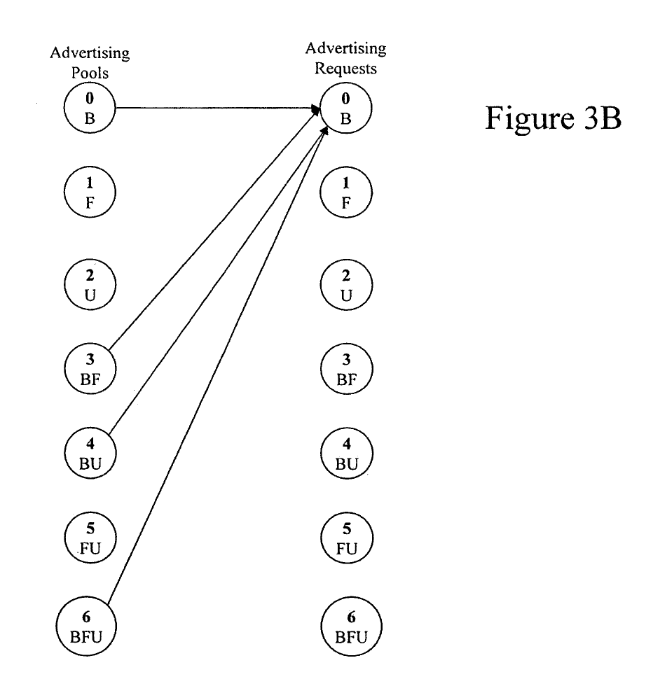

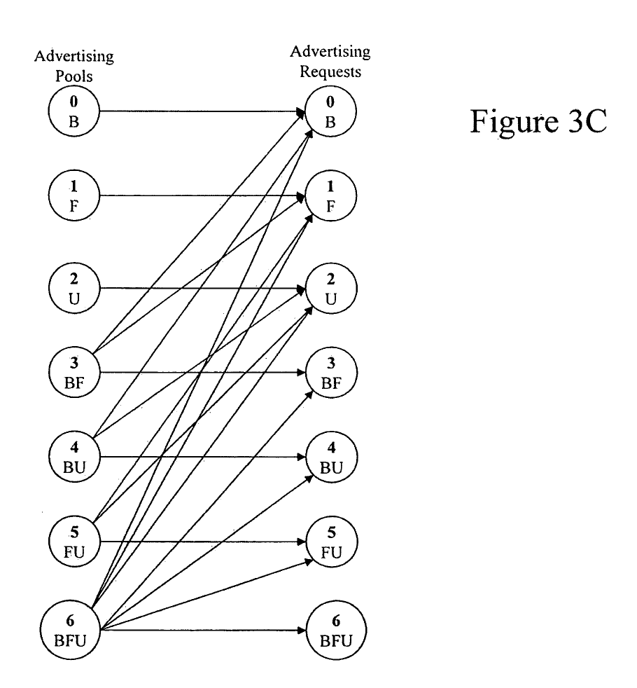

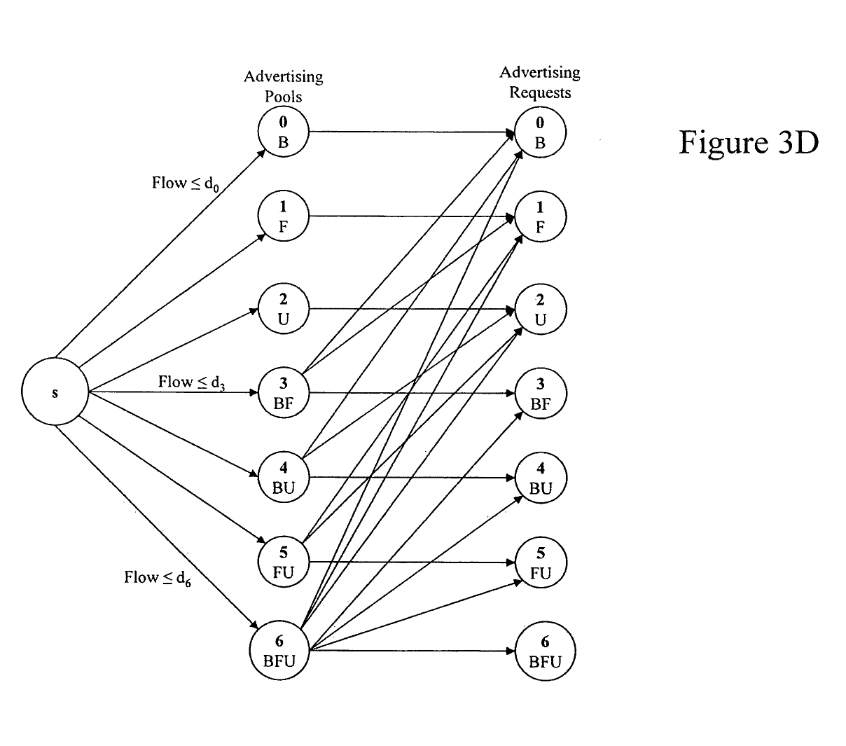

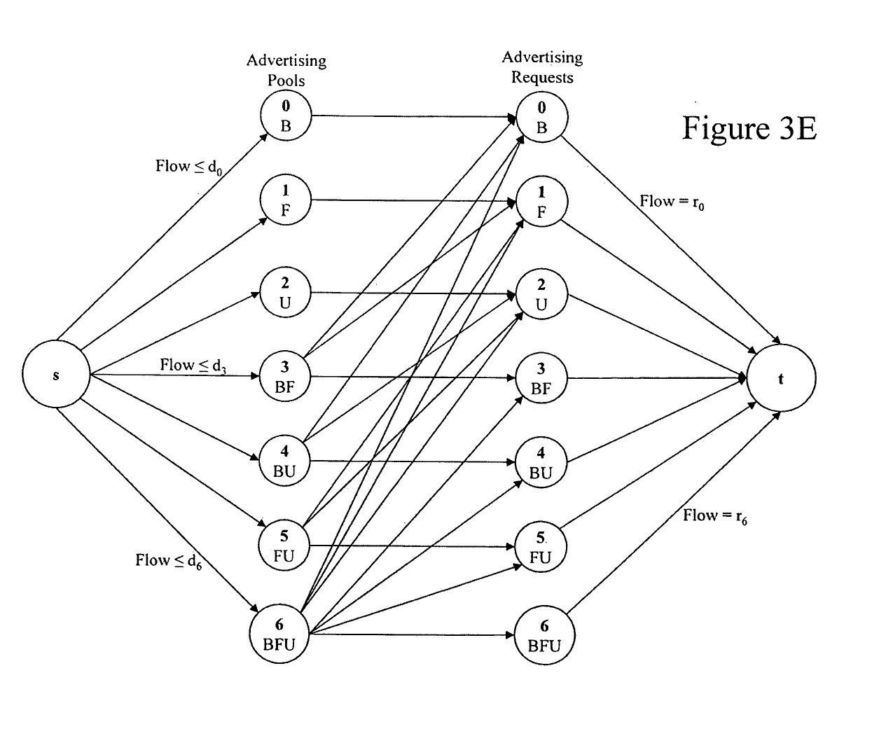

Referring back FIG. 1, there are seven possible sources of advertising opportunities. Similarly, there are seven different types of advertising opportunity request types—though the number of sources and request types will not in general be equal. FIG. 3A illustrates the beginning of a transport network graph with these seven advertising opportunity pools and seven advertising request types.

Only certain advertising pools can satisfy certain advertising requests. Specifically, only a matching profile or a subset of that matching profile can be used to satisfy a particular request profile. For example, a behavior targeted (‘B’) advertising request (request node 0) can only be satisfied by a matching behavior targeted (‘B’) advertising opportunity or its proper subsets advertising opportunities BF, BU, and BFU. These permitted transitions from B, BF, BU, and BFU advertising opportunity pools to the behavior targeted (‘B’) advertising request node for are illustrated in FIG. 3B. FIG. 3C illustrates the transportation network graph of FIG. 3B with all the allowable pool to request transitions filled in. Note that these paths exist only if the advertising opportunity pool on the left can be used to supply the advertising demand on the right.

Next, a universal source node s is added to supply the advertising pools with advertising opportunities as illustrated in FIG. 3D. The size of the flow along the path from the universal source node to an advertising opportunity pool k represents dₖ the amount of advertising opportunities of that particular advertising opportunity type. Finally, a universal destination node has been added on the right as a sink for all the requests as illustrated in FIG. 3E. The flow from an advertising request node k to the destination node represents rₖ the (aggregate) allocated requests volume for profile k. (It is aggregate since it will comprise the volume needed to handle requests plus the rest of that profile's supply if the maximum amount of that type is requested as specified in the second objective function formulation.) FIG. 3E illustrates the overlapping inventory allocation problem expressed as a network transport problem graph.

The method of formulating an overlapping allocation problem into a network transport problem may be performed by a computer program. Specifically, a computer program would simply implement a set of rules that translate overlapping allocation problem constraints into transport network constraints as set forth in the preceding paragraphs.

### First Objective Function

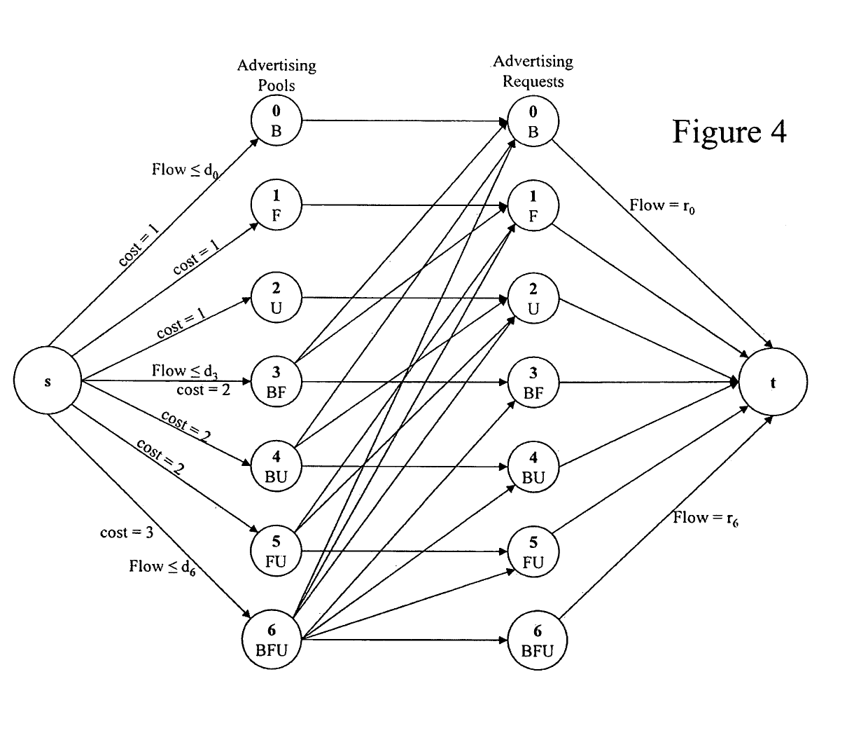

To complete the analogy, an objective function must be formulated. For the first objective function, a lower bound of rₖ was added to the paths from the advertising requests to the terminal node t. This lower bound represents the requests that must be fulfilled. Next, the paths from source to the advertising pools are assigned a cost Vⱼ with all other path costs zero. The objective function is then to determine the minimum cost flow from source node s to, terminal node t. This will provide the solution since minimizing the value of the inventory assigned is equivalent to maximizing the value of the inventory that remains. FIG. 4 illustrates the network configuration for solving the first objective function.

### Second Objective Function

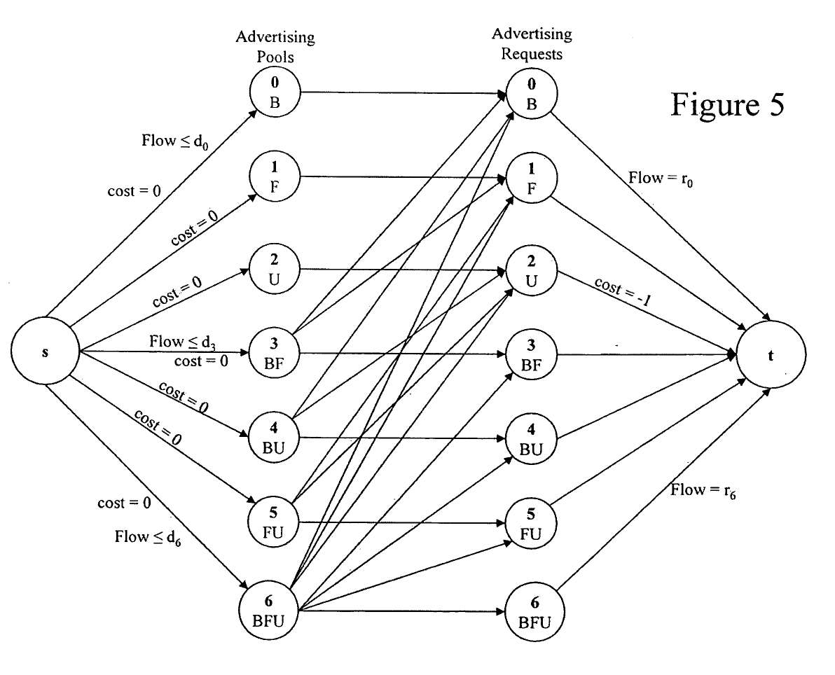

To express the second objective function, a cost of zero is assigned to all the links except for a single link from advertising request type to be maximized to the terminal node. For the type of advertising opportunity to be maximized, the path to the terminal node is set to corresponding to the, queries inventory i with cost of negative one (“−1”). Then, one attempts to determine the minimum cost. Since path from the desired request type has negative one as a cost, finding a minimal cost will maximize the amount of the flow along that path. For example, FIG. 5 illustrates the network configuration for solving the second objective function for a maximum amount of U inventory. As illustrated in FIG. 5, the link from advertising request node 2 for U inventory to the terminal node t has been assigned a cost of −1 such that finding a minimal cost will maximize the amount of flow along that link.

One may formulate more complex problems using the network traffic formulation system of the present invention. For example, one may put costs on both the paths from the source node s to the pool nodes and costs on the paths from the request nodes to the destination node t. The network traffic problem formulation opens up the entire body of network theory for allocation problems.

### Solving Network Transportation Problems

Network transport problems have been examined for many years now. A large number of algorithms and methods exist for solving such problems. Very efficient automated methods, based on specialized versions of the simplex method, exist which can solve such network problems orders of magnitude more quickly than standard algorithms which take no account of the special structure. For example, the book “Algorithms for Network Programming” by J. L. Kennington and R. V. Helgason, Wiley, N.Y., (1980) contains various methods and computer code for solving network transport problems of the type illustrated in FIG. 4 and FIG. 5. Anyone, skilled in the art of computer programming can implement such algorithms and computer code.

Both first objective function and the second objective function variants of the inventory request and allocation problem can be formulated as linear programs for any property/position, given the data on available inventory and the inventory bookings accepted. These problems may also be formulated as network optimization problems for more rapid solution. There are many property/positions, but multiple requests are fully parallelizable and so may be solved rapidly.

The foregoing has described a number of techniques for allocating overlapping inventory. It is contemplated that changes and modifications may be made by one of ordinary skill in the art, to the materials and arrangements of elements of the present invention without departing from the scope of the invention.

We claim:

1. A method of allocating overlapping inventory, said method comprising the steps of:
formulating an overlapping inventory allocation problem as a network transport optimization problem; and
solving said network transport optimization problem with traditional network transport problem methods.

2. The method of allocating overlapping inventory as set forth in claim 1 wherein formulating said overlapping inventory allocation problem as said network transport optimization problem comprises representing a set of inventory pools as a set of pool network nodes and a set of inventory requests as a set of request network nodes.

3. The method of allocating overlapping inventory as set forth in claim 2 wherein said pool network nodes that may satisfy request network nodes are connected with a network transmission path.

4. The method of allocating overlapping inventory as set forth in claim 2 wherein said pool network nodes are coupled to a source network node.

5. The method of allocating overlapping inventory as set forth in claim 4 wherein a flow volume between said source network node and a pool network node corresponds to an inventory amount of said inventory pool associated with said pool network node.

6. The method of allocating overlapping inventory as set forth in claim 4 wherein a cost amount between said source network node and a pool network node corresponds to a value of inventory in said inventory pool associated with said pool network node.

7. The method of allocating overlapping inventory as set forth in claim 2 wherein said request network nodes are coupled to a destination network node.

8. The method of allocating overlapping inventory as set forth in claim 7 wherein a flow volume between a request network node and said destination network node corresponds to an amount of said inventory request associated with said request network node.

9. The method of allocating overlapping inventory as set forth in claim 7 wherein a cost amount between a request network node and said destination network node is set to a negative value to maximize inventory requests associated with said request network node.

10. The method of allocating overlapping inventory as set forth in claim 1 wherein said overlapping inventory problem comprises allocated advertising inventory.

11. A computer-readable medium, said computer-readable medium comprising a set of computer instructions for allocating overlapping inventory, said computer instructions implementing the steps of:
formulating an overlapping inventory allocation problem as a network transport optimization problem; and
solving said network transport optimization problem with traditional network transport problem methods.

12. The computer-readable medium as set forth in claim 11 wherein formulating said overlapping inventory allocation problem as said network transport optimization problem comprises representing a set of inventory pools as a set of pool network nodes and a set of inventory requests as a set of request network nodes.

13. The computer-readable medium as set forth in claim 12 wherein said pool network nodes that may satisfy request network nodes are connected with a network transmission path.

14. The computer-readable medium as set forth in claim 12 wherein said pool network nodes are coupled to a source network node.

15. The computer-readable medium as set forth in claim 14 wherein a flow volume between said source network node and a pool network node corresponds to an inventory amount of said inventory pool associated with said pool network node.

16. The computer-readable medium as set forth in claim 14 wherein a cost amount between said source network node and a pool network node corresponds to a value of inventory in said inventory pool associated with said pool network node.

17. The computer-readable medium as set forth in claim 12 wherein said request network nodes are coupled to a destination network node.

18. The computer-readable medium as set forth in claim 17 wherein a flow volume between a request network node and said destination network node corresponds to an amount of said inventory request associated with said request network node.

19. The computer-readable medium as set forth in claim 17 wherein a cost amount between a request network node and said destination network node is set to a negative value to maximize inventory requests associated with said request network node.

20. The computer-readable medium as set forth in claim 11 wherein said overlapping inventory problem comprises allocated advertising inventory.
